(19) United States
(12) Patent Application Publication
(10) Pub. No.: US 2015/0151222 A1
(43) Pub. Date: Jun. 4, 2015

(54) FLUID FILTER WITH MULTIPLE PARALLEL FILTER ELEMENTS, AND RELATED METHODS

(71) Applicant: SIMMONS DEVELOPMENT, LLC, Salt Lake City, UT (US)

(72) Inventor: Tom M. SIMMONS, Kamas, UT (US)

(21) Appl. No.: 14/558,371

(22) Filed: Dec. 2, 2014

Related U.S. Application Data
(60) Provisional application No. 61/910,786, filed on Dec. 2, 2013.

(51) Int. Cl. B01D 29/52; B01D 29/00

(52) U.S. Cl. CPC B01D 29/52; B01D 29/0093

(57) ABSTRACT

A fluid filter may comprise a unitary head comprising a fluid inlet in fluid communication with an inlet manifold, and a fluid outlet in communication with an outlet manifold. A plurality of filter housings may be connected to the unitary head, and each filter housing of the plurality of filter housings may be individually removable from the unitary head. The fluid filter may also include a plurality of filter cartridges, and each filter cartridge of the plurality of filter cartridges may be disposed within a corresponding filter housing of the plurality of filter housings. The inlet manifold may be configured to provide fluid communication in parallel between the fluid inlet and an input side of each filter cartridge. The outlet manifold may be configured to provide fluid communication in parallel between the fluid outlet and an output side of each filter cartridge.

### CROSS-REFERENCE TO RELATED APPLICATION

This application claims the benefit of U.S. Provisional Patent Application Ser. No. 61/910,786, filed Dec. 2, 2013, the disclosure of which is hereby incorporated herein in its entirety by this reference.

### TECHNICAL FIELD

Embodiments of the present disclosure relate generally to fluid filters that include multiple filtration elements. Additional embodiments include methods of making and using such fluid filters.

### BACKGROUND

In many industries there is a need to pressurize and/or transport fluid using fluid pumps. For example, fluid pumps are found in industries such as shipping, processing, manufacturing, irrigation, gasoline supply, air conditioning systems, flood control, marine services, etc. Different industries may require pumping of a wide variety of subject fluids. For example, industries may pump air, oil, water, acid, etc.

Particle contamination in fluids is a common problem and may be a major contributor to failure in pump and/or other fluid handling system components. Particulates and other matter may be removed from a subject fluid by pumping the subject fluid through a fluid filter having a filter element therein.

Filter elements may create resistance to the flow of fluid, the magnitude of which depends on variables that may include certain characteristics of the filter media and the desired purity of the filtrate (i.e., amount and size of particle contamination desired to be removed). Resistance to flow may lead to undesirable losses in pressure, flow rate, and efficiency of the fluid handling system. The flow resistance created by filtration elements can be reduced by increasing the surface area of the filtration element over which the fluid flow is distributed. The surface area may be increased by, for example, increasing the size of the filter, or by utilizing multiple filter elements. However, increasing filter size may require a corresponding increase in size of the filter housing, and the force acting on the housing as a result of a given fluid pressure increases proportionally with the housing surface area. Depending on the design of the housing and the operating pressure of the system, some materials may lack the strength to withstand the forces associated with large housings. Multiple filter element arrangements may require extra fittings and plumbing components, resulting in inefficient use of space, greater component cost, and longer assembly time.

### BRIEF SUMMARY

In one embodiment, a fluid filter may comprise a unitary head comprising a fluid inlet in fluid communication with an inlet manifold and a fluid outlet in communication with an outlet manifold. A plurality of filter housings may be connected to the unitary head, and each filter housing of the plurality of filter housings may be individually removable from the unitary head. The fluid filter may also comprise a plurality of filter cartridges, and each filter cartridge of the plurality of filter cartridges may be disposed within a corresponding filter housing of the plurality of filter housings. The inlet manifold may be configured to provide fluid communication in parallel between the fluid inlet and an input side of each filter cartridge of the plurality of filter cartridges, and the outlet manifold may be configured to provide fluid communication in parallel between the fluid outlet and an output side of each filter cartridge of the plurality of filter cartridges.

In another embodiment, a method of manufacturing a fluid filter may comprise providing a unitary head that includes a fluid inlet, an inlet manifold in the unitary head, a fluid outlet, and an outlet manifold in the unitary head. The fluid inlet is in fluid communication with the inlet manifold, and the fluid outlet is in fluid communication with the outlet manifold. The method further includes providing a plurality of filter housings. Each of the filter housings is configured to be individually attached to the unitary head. Each filter housing of the plurality of filter housings is attached to the unitary head with a filter cartridge disposed within each filter housing, such that the inlet manifold divides in parallel an input fluid flow entering the fluid inlet into flow branches and directs each parallel flow branch to an inlet side of each respective filter cartridge, and such that the outlet manifold accepts in parallel a flow branch from an outlet side of each respective filter cartridge and recombines each flow branch into an output flow and directs the output flow to the fluid outlet.

### BRIEF DESCRIPTION OF THE DRAWINGS

FIG. 1 is a perspective view of a fluid filter according to an embodiment of the disclosure;

FIG. 2 is a cross-sectional side view of the fluid filter of FIG. 1;

FIG. 3 is a cross-sectional perspective view of the fluid filter of FIG. 1, the cross-section taken in a plane transverse to the cross-sectional plane of FIG. 2; and

FIG. 4 is a cross-sectional perspective view of an embodiment of a filter element of the fluid filter of FIGS. 1 through 3.

### DETAILED DESCRIPTION

The illustrations presented herein are not meant to be actual views of any particular material, apparatus, system, or method, but are merely idealized representations, which are employed to describe example embodiments of the present invention.

As used herein, the term “substantially” in reference to a given parameter means to a degree that one skilled in the art would understand that the given parameter, property, or condition is met with a small degree of variance, such as within acceptable manufacturing tolerances.

As used herein, the term “manifold” means and includes a single passageway branching into a plurality of passageways, or a plurality of passageways branching into a single passageway.

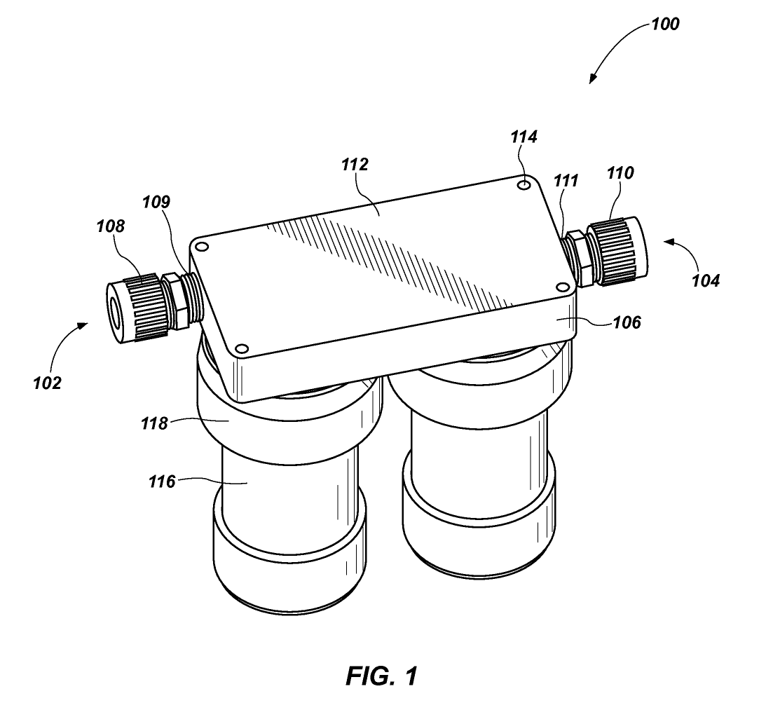

FIG. 1 illustrates a fluid filter 100 of the present disclosure. The fluid filter 100 may include a fluid inlet 102 into which a flow of a subject fluid (i.e., a feed) may enter the fluid filter 100, and a fluid outlet 104 from which a flow of filtered fluid (i.e., a filtrate) may leave the fluid filter 100. The fluid inlet 102 and the fluid outlet 104 may be disposed within a unitary head 106. In some embodiments, the fluid inlet 102 and the fluid outlet 104 may include an inlet fitting 108 disposed at least partially within an inlet port 109 formed in the unitary head 106 and an outlet fitting 110 disposed at least partially within an outlet port 111 formed in the unitary head 106. The inlet and outlet fittings 108 and 110 may be configured for connection to external plumbing, for example, lines, hoses, or tubing, to direct the fluid flow between a pump and/or other equipment and the fluid filter 100. The unitary head 106 may include features configured to enable the fluid filter 100 to be attached to other components of a fluid system. For example, the unitary head 106 may include a generally planar surface 112 configured to abut a surface onto which the fluid filter 100 may be affixed, for example, a frame or mounting plate of another component (not shown). The unitary head may include holes 114 through which hardware, such as bolts or screws, may be passed to attach the unitary head 106 to the frame or mounting plate.

In some embodiments, at least the fluid-contacting surfaces of the unitary head 106 may be substantially comprised of a fluoropolymer material. By way of example and not limitation, the unitary head 106 may comprise one or more of neoprene, buna-N, ethylene diene M-class (EPDM), VITON®, polyurethane, HYTREL®, SANTOPRENE®, fluorinated ethylene-propylene (FEP), perfluoroalkoxy fluorocarbon resin (PFA), ethylene-chlorotrifluoroethylene copolymer (ECTFE), ethylene-tetrafluoroethylene copolymer (ETFE), nylon, polyethylene, polyvinylidene fluoride (PVDF), NORDEL™, and nitrile. In some embodiments, the unitary head 106 may be formed from a single piece of material, e.g., by machining Alternatively, the unitary head 106 may be formed from a polymer by injection molding, casting, or other manufacturing methods.

The fluid filter 100 may include a plurality of filter housings 116 attached to the unitary head 106. Each filter housing 116 of the plurality of filter housings may be individually removable from the unitary head 106. For example, in one embodiment of the disclosure, the fluid filter 100 may include two filter housings 116, each affixed to the unitary head 106 by individually removable retaining rings 118. The filter housings 116 may be formed using, for example, the materials and methods described above in connection with the unitary head 106. In some embodiments, at least the fluid-contacting surfaces of the filter housings 116 may comprise a flouropolymer material.

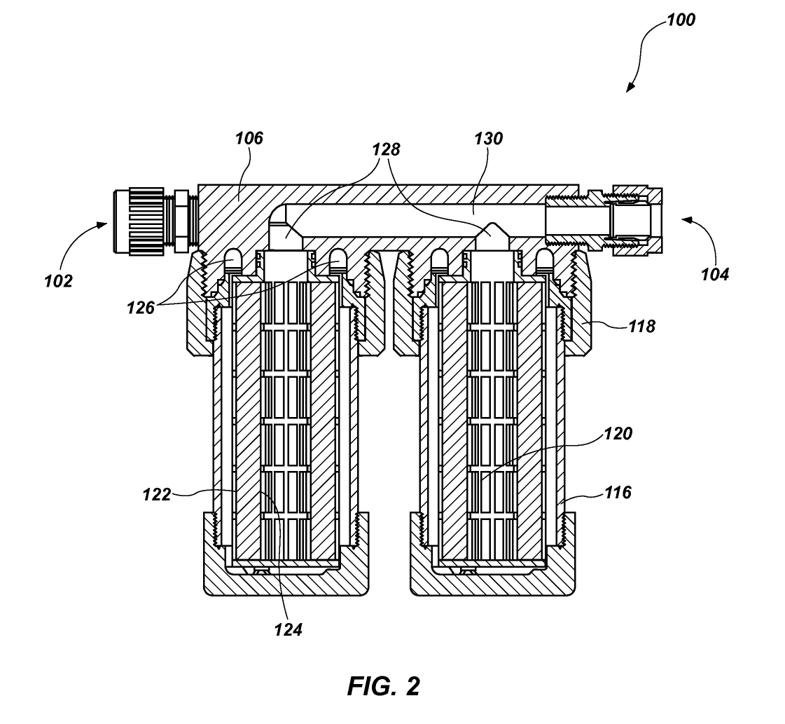

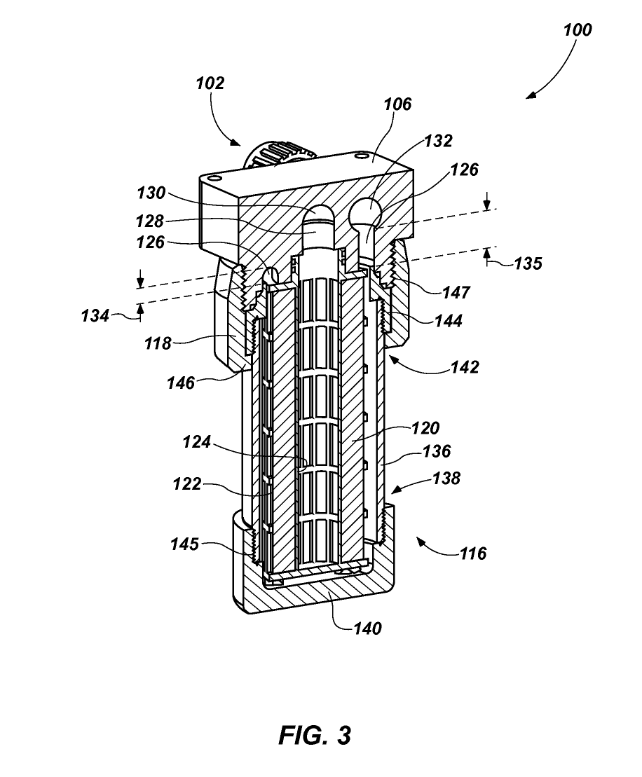

Referring now to FIG. 2, each filter housing 116 of the plurality of filter housings may surround and enclose a filtration element, for example, a filter cartridge 120. Each filter cartridge 120 may include an input side 122, into which the flow of subject fluid may enter, and an output side 124, from which the flow of filtered fluid may exit. The input side 122 of each filter cartridge 120 may be in fluid communication with a filter inlet port 126 of a plurality of filter inlet ports formed in the unitary head 106. Each filter inlet port 126 of the plurality of filter inlet ports may be in direct fluid communication (i.e., fluid communication in parallel), with the fluid inlet 102. For example, each filter inlet port 126 may be connected to the fluid inlet 102 through an inlet manifold, as shown and described below in connection with FIG. 3.

The output side 124 of each filter cartridge 120 may be in fluid communication with a filter outlet port 128 of a plurality of filter outlet ports formed in the unitary head 106. Each filter outlet port 128 of the plurality of filter outlet ports may be in direct (i.e., parallel) fluid communication with the fluid outlet 104. For example, as shown in FIG. 2, each filter outlet port 128 of the plurality of filter outlet ports may be in fluid communication with an outlet manifold 130. As a non-limiting example, the outlet manifold 130 may be formed as an elongated, substantially cylindrical cavity in the unitary head 106. For example, the outlet manifold 130 may be formed by drilling or milling a cavity in the unitary head 106 with a drill bit or a ball mill. Similarly, each filter outlet port 128 of the plurality of filter outlet ports may be formed by drilling or milling through the unitary head 106, forming an opening for fluid to pass into the outlet manifold 130 and subsequently to the fluid outlet 104.

FIG. 3 illustrates the fluid filter 100 shown in connection with FIGS. 1 and 2, the cross-section of FIG. 3 taken in a plane orthogonal to the plane of the cross-section of FIG. 2. The unitary head 106 may include an inlet manifold 132 in fluid communication with the fluid inlet 102. The unitary head 106 may include a plurality of filter inlet ports 126 (only one filter inlet port 126 shown in the plane of FIG. 3), each filter inlet port 126 in direct (i.e., parallel) fluid communication with the inlet manifold 132. Each filter inlet port 126 of the plurality of filter inlet ports may be formed as a substantially annular recess disposed in the unitary head 106 and positioned above the input side 122 of the filter cartridge 120. The inlet manifold 132 may be formed similarly to the outlet manifold 130 described above in connection with FIG. 2, i.e., the inlet manifold 132 may be formed by milling or drilling an elongated, cylindrical cavity in the unitary head 106. Each filter inlet port 126 of the plurality of filter inlet ports may be formed so that a portion of each filter inlet port 126 forms an opening into the inlet manifold 132 for fluid to pass from the inlet manifold 132 into each filter inlet port 126 of the plurality of filter inlet ports and subsequently to the input side 122 of each filter cartridge 120 of the plurality of filter cartridges.

In some embodiments, each filter inlet port 126 may have a substantially annular shape, the substantially annular shape having a height 134, 135 (indicated by dashed lines) varying around a circumference of the substantially annular shape. The height 134, 135 may vary from a minimum height 134 at a location opposite the inlet manifold 132 across a diameter of the filter cartridge 120, to a maximum height 135 at a location proximate the inlet manifold 132. The filter inlet port 126 may form an opening into the inlet manifold 132 near the maximum height 135 proximate the inlet manifold 132.

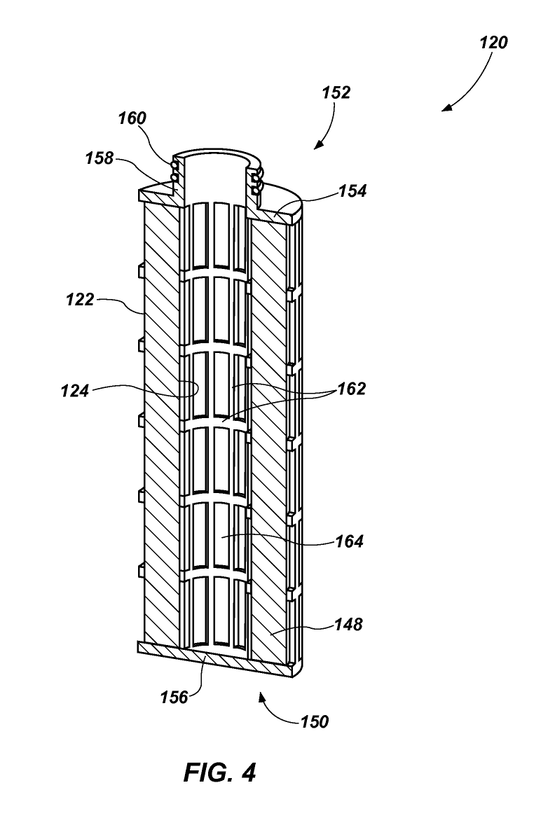

In operation, a flow of fluid in which particle contaminants may be entrained may enter the fluid inlet 102 urged by a pressure differential created by, for example, a fluid pump, and flow into the inlet manifold 132. From the inlet manifold 132, portions of the flow of fluid may enter each filter inlet port 126 of the plurality of inlet ports (i.e., fluid may flow simultaneously from the inlet manifold 132 into each filter inlet port 126 in parallel branches). Each parallel flow branch may then flow into the input side 122 of each filter cartridge 120 of the plurality of filter cartridges and pass through a filtration media (described in more detail in connection with FIG. 4 below) configured to remove (e.g., reduce or eliminate) particle contaminants from the flowing subject fluid. The filtered fluid may then flow simultaneously from the output side 124 of each filter cartridge 120, into each filter outlet port 128, and the parallel branches of fluid may recombine into a single fluid flow in the outlet manifold 130 and leave the fluid filter 100 through the fluid outlet 104 (FIGS. 1 and 2).

Providing multiple filter cartridges 120 with parallel flow paths between the fluid inlet 102 and the fluid outlet 104 may increase filter surface area and consequently reduce the losses in pressure and flow rate typically associated with fluid filters. The unitary head 106 may enable significantly improved packaging efficiency compared to separately-plumbed multiple filter arrangements. Moreover, the plurality of filter cartridges 120 may provide increased filter surface area without a corresponding increase in the size of each individual filter housing 116.

Referring again to FIG. 3, each filter cartridge 120 of the plurality of filter cartridges may be contained within a filter housing 116. Each filter housing 116 may be affixed to, and individually removable from, the unitary head 106. Furthermore, each filter housing 116 may be configured to withstand a force applied to the housing 116, the force equal to the pressure of the flowing fluid multiplied by a total interior area of the filter housing 116 over which the pressurized fluid acts. Each filter housing 116 may be configured to enclose and seal each filter cartridge 120 and retain each filter cartridge 120 to the unitary head 106. For example, each filter housing 116 of the plurality of filter housings may include a substantially hollow cylindrical body 136 with a first end 138 and a second end 142, an end cap 140 attached to the first end 138, and a sealing ring 144 attached to the second end 142. The end cap 140 and the sealing ring 144 may be attached to the cylindrical body 136 by threads 145 as shown in FIG. 3, or alternatively, may be attached by chemical bonding with an adhesive, by friction welding, or may be integrally formed with the cylindrical body 136. The sealing ring 144 may be configured to create a fluid seal between the unitary head 106 and each filter housing 116. In some embodiments, the sealing ring 144 may be configured to form a seal by directly contacting the unitary head 106. In other embodiments, the sealing ring 144 may include one or more sealing elements such as 0-rings or other compressible seals disposed between the sealing ring 144 and the unitary head 106.

Each filter housing 116 of the plurality of filter housings may be affixed to the unitary head 106 by a retaining ring 118. The retaining ring 118 may include a protuberance (e.g., flange) 146 configured to abut the sealing ring 144 and retain the filter housing 116 to the unitary head 106. The retaining ring 118 may be joined to the unitary head 106 by threads 147 formed in the retaining ring 118 configured to mesh with complementary threads formed on the unitary head 106. Alternatively, the retaining ring 118 may be joined to the unitary head 106 by clamps, clips, or other mechanical retaining devices. When it is necessary or otherwise desired to replace the filter cartridge 120, the retaining ring 118 may be removed from the unitary head 106, the filter cartridge 120 may be removed from the fluid filter 100, and a replacement filter cartridge may be placed within the filter housing 116 or inserted in the unitary head 106. The filter housing 116 may then be replaced on the unitary head 106 and the retaining ring 118 may be reinstalled to retain the filter housing 116 and filter cartridge 120 on the unitary head 106. Each filter housing 116 of the plurality of filter housings may be individually removable from the unitary head 106 by removing the retaining ring 118 associated with each filter housing 116.

Referring now to FIG. 4, each filter cartridge 120 of the plurality of filter cartridges may include a filter element 148 comprising a filtration media. In some embodiments of the disclosure, the filter element 148 may have a substantially cylindrical, hollow shape with a first end 150 and a second end 152. The filter element 148 may comprise filtration media such as woven or matted fibers such as cellulose, fiberglass, aramid, polyester, nylon, flouropolymer fibers, or other materials. Additionally or alternatively, the filter element 148 may comprise a filtration media with a porous membrane. In some embodiments, the filtration media may comprise a material resistant or impervious to degradation by fluids such as strong acids. The filtration media may include multiple cylindrical layers forming the filter element 148, and the filtration media may include pleats to increase the filtering surface area. As described above in connection with FIGS. 2 and 3, each filter cartridge may include an input side 122 (i.e., a side into which the feed flows) and an output side 124 (i.e., a side from which the filtrate flows).

Each filter cartridge 120 may include a supporting structure 154. The supporting structure 154 may comprise a material having sufficient strength and rigidity to maintain the shape and prevent collapse of the filter element 148 as the pressurized fluid acts on the surface area of the filter element 148. For example, in some embodiments, at least all the fluid-contacting surfaces of the supporting structure may be comprised of a fluoropolymer material. The supporting structure 154 may include a closed end plate 156 disposed at the first end 150 of the filter element 148. The supporting structure 154 may also include a sealing flange 158 disposed at the second end 152 of the filter element 148. The sealing flange may include one or more sealing elements 160, for example, 0-rings or other compressible seals, configured to create a fluid seal between the filter cartridge 120 and the unitary head 106 (FIG. 2).

The supporting structure 154 may include a lattice-type structure 162 disposed over exposed surfaces of the filter element 148 corresponding to the input side 122 and the output side 124 of the filter cartridge 120. For example, in some embodiments, the lattice-type structure 162 may include an array of mutually perpendicularly oriented, spaced linear supports defining apertures (e.g., openings) 164 through which the filter element 148 is exposed. In some embodiments, the supporting structure 154 may be formed by machining the openings 164 in a substantially cylindrical shell to form the lattice-type structure 162. In other embodiments, the supporting structure may be formed by injection molding, casting, or other processes. The openings 164 may be substantially rectangular in shape, as shown in FIG. 4, or may be circular, oval, trapezoidal, or any other suitable shape. The shape, size, and number of openings 164 may be chosen to maximize (e.g., increase) the surface area of the filter element 148 exposed through the openings 164 while substantially maintaining the rigidity of the supporting structure 154.

In some embodiments, a method of manufacturing a fluid filter may include providing a unitary head. A fluid inlet and an inlet manifold may be formed in the unitary head, and the fluid inlet and the inlet manifold may be in fluid communication. A fluid outlet and an outlet manifold may be formed in the unitary head, and the fluid outlet and the outlet manifold may be in fluid communication. The method of manufacturing a fluid filter may include forming a plurality of filter housings, and each filter housing may be configured to be individually attached to the unitary head. A plurality of cartridge filters may be formed, and each cartridge filter of the plurality of cartridge filters may be configured to be disposed within a corresponding filter housing of the plurality of filter housings. Each filter cartridge of the plurality of filter cartridges may include an inlet side and an outlet side. The inlet manifold may be configured to divide an input fluid flow entering the fluid inlet into parallel flow branches and direct each parallel flow branch to the inlet side of each filter cartridge of the plurality of filter cartridges. The outlet manifold may be configured to accept a parallel flow branch from the outlet side of each filter cartridge of the plurality of filter cartridges, recombine each parallel flow branch into an output flow, and direct the output flow to the fluid outlet. Providing a unitary head may include providing a unitary head wherein at least all fluid-contacting surfaces of the unitary head are at least substantially comprised of a flouropolymer. Forming at least one of the inlet manifold and the outlet manifold may include forming an elongated, generally cylindrical cavity in the unitary head.

Additional, non-limiting embodiments within the scope of the present disclosure include, but are not limited to:

### Embodiment 1

A fluid filter, comprising: a unitary head comprising a fluid inlet in fluid communication with an inlet manifold and a fluid outlet in communication with an outlet manifold; a plurality of filter housings connected to the unitary head, each filter housing of the plurality of filter housings being individually removable from the unitary head; and a plurality of filter cartridges, each filter cartridge of the plurality of filter cartridges disposed within a corresponding filter housing of the plurality of filter housings, wherein the inlet manifold is configured to provide fluid communication in parallel between the fluid inlet and an input side of each filter cartridge of the plurality of filter cartridges, and the outlet manifold is configured to provide fluid communication in parallel between the fluid outlet and an output side of each filter cartridge of the plurality of filter cartridges.

### Embodiment 2

The fluid filter of Embodiment 1, wherein at least all fluid-contacting surfaces of the unitary head are at least substantially comprised of a flouropolymer.

### Embodiment 3

The fluid filter of Embodiment 1 or Embodiment 2, wherein at least all fluid-contacting surfaces of each filter housing of the plurality of filter housings are at least substantially comprised of a flouropolymer.

### Embodiment 4

The fluid filter of any one of Embodiments 1 through 3, wherein each filter housing of the plurality of filter housings has a substantially cylindrical shape.

### Embodiment 5

The fluid filter of Embodiment 4, wherein each filter housing of the plurality of filter housings comprises a hollow cylindrical body, an end cap disposed at a first end of the hollow cylindrical body, and a sealing ring disposed at a second end of the hollow cylindrical body, the second end configured to couple to the unitary head.

### Embodiment 6

The fluid filter of any one of Embodiments 1 through 5, wherein each filter housing of the plurality of filter housings is attached to the unitary head by a retaining ring.

### Embodiment 7

The fluid filter of Embodiment 6, wherein the retaining ring comprises threads configured to interact with complementary threads disposed on the unitary head.

### Embodiment 8

The fluid filter of any one of Embodiments 1 through 7, wherein the inlet manifold comprises a generally cylindrical passage formed in the unitary head in fluid communication with a plurality of inlet ports formed in the unitary head.

### Embodiment 9

The fluid filter of Embodiment 8, wherein each inlet port of the plurality of inlet ports comprises a substantially annular recess formed in the unitary head, each annular recess having a height varying around a circumference of the annular recess.

### Embodiment 10

The fluid filter of Embodiment 9, wherein each annular recess of each inlet port is connected to the inlet manifold at a location where the height of the annular recess is greatest.

### Embodiment 11

The fluid filter of any one of Embodiments 1 through 10, wherein the outlet manifold comprises a generally cylindrical passage formed in the unitary head and a plurality of outlet ports formed in the unitary head and extending into the generally cylindrical cavity.

### Embodiment 12

The fluid filter of any one of Embodiments 1 through 11, wherein the plurality of filter housings comprises two filter housings and the plurality of filter cartridges comprises two filter cartridges.

### Embodiment 13

The fluid filter of any one of Embodiments 1 through 12, wherein each filter cartridge of the plurality of filter cartridges comprises a filter element comprised of a filtration media and having a substantially cylindrical shape, and a supporting structure disposed over at least one exposed surface of the filter element.

### Embodiment 14

The fluid filter of Embodiment 13, wherein the filter element comprises a substantially cylindrical interior cavity and the supporting structure is disposed over both an exterior exposed surface of the filtration media and over an interior exposed surface of the filtration media.

### Embodiment 15

The fluid filter of Embodiments 13 or 14, wherein the supporting structure comprises a closed end plate disposed at a first end of the substantially cylindrical filter element.

### Embodiment 16

The fluid filter of any one of Embodiments 13 through 15, wherein the supporting structure comprises a sealing flange comprising at least one sealing element.

### Embodiment 17

The fluid filter of any one of Embodiments 13 through 16, wherein at least all fluid-contacting surfaces of the supporting structure are at least substantially comprised of a flouropolymer.

### Embodiment 18

A method of manufacturing a fluid filter, comprising: providing a unitary head including: a fluid inlet; an inlet manifold in the unitary head, the fluid inlet in fluid communication with the inlet manifold; a fluid outlet; and an outlet manifold in the unitary head, the fluid outlet in fluid communication with the outlet manifold; providing a plurality of filter housings, each filter housing of the plurality of filter housings configured to be individually attached to the unitary head; and attaching each filter housing of the plurality of filter housings to the unitary head with a filter cartridge disposed within each filter housing of the plurality of filter housings such that the inlet manifold divides in parallel an input fluid flow entering the fluid inlet into flow branches and directs each parallel flow branch to an inlet side of each respective filter cartridge, and such that the outlet manifold accepts in parallel a flow branch from an outlet side of each respective filter cartridge and recombines each flow branch into an output flow and directs the output flow to the fluid outlet.

### Embodiment 19

The method of Embodiment 18, wherein providing a unitary head further comprises selecting the unitary head to comprise a unitary head having fluid-contacting surfaces comprised of a flouropolymer.

### Embodiment 20

The method of Embodiment 18 or Embodiment 19, further comprising forming at least one of the unitary head and a filter housing of the plurality of filter housings.

While certain illustrative embodiments have been described in connection with the figures, those of ordinary skill in the art will recognize and appreciate that the scope of this disclosure is not limited to those embodiments explicitly shown and described herein. Rather, many additions, deletions, and modifications to the embodiments described herein may be made to produce embodiments within the scope of this disclosure, such as those hereinafter claimed, including legal equivalents. In addition, features from one disclosed embodiment may be combined with features of another disclosed embodiment while still being within the scope of this disclosure, as contemplated by the inventor.

What is claimed is:

1. A fluid filter, comprising:
a unitary head comprising a fluid inlet in fluid communication with an inlet manifold and a fluid outlet in communication with an outlet manifold;
a plurality of filter housings connected to the unitary head, each filter housing of the plurality of filter housings being individually removable from the unitary head; and
a plurality of filter cartridges, each filter cartridge of the plurality of filter cartridges disposed within a corresponding filter housing of the plurality of filter housings, wherein the inlet manifold is configured to provide fluid communication in parallel between the fluid inlet and an input side of each filter cartridge of the plurality of filter cartridges, and the outlet manifold is configured to provide fluid communication in parallel between the fluid outlet and an output side of each filter cartridge of the plurality of filter cartridges.

2. The fluid filter of claim 1, wherein at least all fluid-contacting surfaces of the unitary head are at least substantially comprised of a flouropolymer.

3. The fluid filter of claim 1, wherein at least all fluid-contacting surfaces of each filter housing of the plurality of filter housings are at least substantially comprised of a flouropolymer.

4. The fluid filter of claim 1, wherein each filter housing of the plurality of filter housings has a substantially cylindrical shape.

5. The fluid filter of claim 4, wherein each filter housing of the plurality of filter housings comprises a hollow cylindrical body, an end cap disposed at a first end of the hollow cylindrical body, and a sealing ring disposed at a second end of the hollow cylindrical body, the second end configured to couple to the unitary head.

6. The fluid filter of claim 4, wherein each filter housing of the plurality of filter housings is attached to the unitary head by a retaining ring.

7. The fluid filter of claim 6, wherein the retaining ring comprises threads configured to interact with complementary threads disposed on the unitary head.

8. The fluid filter of claim 1, wherein the inlet manifold comprises a generally cylindrical passage formed in the unitary head in fluid communication with a plurality of inlet ports formed in the unitary head.

9. The fluid filter of claim 8, wherein each inlet port of the plurality of inlet ports comprises a substantially annular recess formed in the unitary head, each annular recess having a height varying around a circumference of the annular recess.

10. The fluid filter of claim 9, wherein each annular recess of each inlet port is connected to the inlet manifold at a location where the height of the annular recess is greatest.

11. The fluid filter of claim 1, wherein the outlet manifold comprises a generally cylindrical passage formed in the unitary head and a plurality of outlet ports formed in the unitary head and extending into the generally cylindrical cavity.

12. The fluid filter of claim 1, wherein the plurality of filter housings comprises two filter housings and the plurality of filter cartridges comprises two filter cartridges.

13. The fluid filter of claim 1, wherein each filter cartridge of the plurality of filter cartridges comprises a filter element comprised of a filtration media and having a substantially cylindrical shape, and a supporting structure disposed over at least one exposed surface of the filter element.

14. The fluid filter of claim 13, wherein the filter element comprises a substantially cylindrical interior cavity and the supporting structure is disposed over both an exterior exposed surface of the filtration media and over an interior exposed surface of the filtration media.

15. The fluid filter of claim 13, wherein the supporting structure comprises a closed end plate disposed at a first end of the substantially cylindrical filter element.

16. The fluid filter of claim 13, wherein the supporting structure comprises a sealing flange comprising at least one sealing element.

17. The fluid filter of claim 13, wherein at least all fluid-contacting surfaces of the supporting structure are at least substantially comprised of a flouropolymer.

18. A method of manufacturing a fluid filter, comprising:
providing a unitary head including:
a fluid inlet;
an inlet manifold in the unitary head, the fluid inlet in fluid communication with the inlet manifold;
a fluid outlet; and
an outlet manifold in the unitary head, the fluid outlet in fluid communication with the outlet manifold;
providing a plurality of filter housings, each filter housing of the plurality of filter housings configured to be individually attached to the unitary head; and
attaching each filter housing of the plurality of filter housings to the unitary head with a filter cartridge disposed within each filter housing of the plurality of filter housings such that the inlet manifold divides in parallel an input fluid flow entering the fluid inlet into flow branches and directs each parallel flow branch to an inlet side of each respective filter cartridge, and such that the outlet manifold accepts in parallel a flow branch from an outlet side of each respective filter cartridge and recombines each flow branch into an output flow and directs the output flow to the fluid outlet.

19. The method of claim 18, wherein providing a unitary head further comprises selecting the unitary head to comprise a unitary head having fluid-contacting surfaces comprised of a flouropolymer.

20. The method of claim 18, further comprising forming at least one of the unitary head and a filter housing of the plurality of filter housings.
